(19) United States
(12) Patent Application Publication
(10) Pub. No.: US 2016/0110670 A1
(43) Pub. Date: Apr. 21, 2016

(54) RELATIONAL ANALYSIS OF BUSINESS OBJECTS

(71) Applicant: SAP SE, Walldorf (DE)

(72) Inventors: Swarnava Chatterjee, Varanasi (IN); Prabhu Jayakumar, Chennai (IN); Vinothkumar Vaithianathan, Puducherry (IN); Sunny Lakhmani, Lucknow (IN); Ashwin K S, Kochi (IN); Monissha M.T. Agil, Erode (IN)

(21) Appl. No.: 14/518,636

(22) Filed: Oct. 20, 2014

(51) Int. Cl. G06Q 10/06; G06T 11/20

(52) U.S. Cl. CPC G06Q 10/06393; G06T 11/206

(57) ABSTRACT

Systems, methods, and non-transitory computer-readable mediums having program instructions thereon, provide for analyzing a business object corresponding to a data source with a relational analysis graphical user interface application. The relational analysis graphical user interface application facilitates the analysis of business objects corresponding to a data source through an interactive graphical path. The interactive graphical path depicts a suggested analysis path relating to the business object (i.e., entity). The suggested analysis path corresponds to any relationships (direct or indirect) between the selected entity and other related entities (i.e., corresponding to other data sources). Further, the relationship between the entities is determined based on a heuristic logic.

### FIELD

The present disclosure relates generally to a graphical user interface application to analyze a business object corresponding to a data source.

### BRIEF DESCRIPTION OF THE DRAWINGS

The accompanying drawings illustrate the various embodiments and, together with the description, further serve to explain the principles of the embodiments and to enable one skilled in the pertinent art to make and use the embodiments.

FIG. 1 illustrates an embodiment of a system utilizing a relational analysis graphical user interface application.

FIG. 2 illustrates an embodiment of a method of utilizing the relational analysis graphical user interface application.

FIG. 3 illustrates an embodiment of the interaction between the elements of the system.

FIG. 4A illustrates an embodiment of the home page of the relational analysis application.

FIG. 4B illustrates an embodiment of the page utilized to define an entity.

FIG. 4C illustrates an embodiment of the page utilized to edit the entity.

FIG. 4D illustrates an embodiment of the page utilized to pre-define the associations of the entity.

FIG. 4E illustrates an embodiment of the page utilized to configure the visualization of the entity during runtime.

FIG. 4F illustrates an embodiment of the page utilized to analyze the entity.

### DETAILED DESCRIPTION

According to an embodiment of the present disclosures, systems, methods, and non-transitory computer-readable mediums having program instructions thereon, provide for analyzing a business object corresponding to a data source with a relational analysis graphical user interface application. In an embodiment, the relational analysis graphical user interface application facilitates the analysis of business objects corresponding to a data source through an interactive graphical path. In an embodiment, the interactive graphical path depicts at least one suggested interactive analysis path relating to the business object (i.e., entity). In an embodiment, the at least one suggested interactive analysis path corresponds to any relationships (direct or indirect) between the selected entity and other related entities (i.e., corresponding to other data sources). In an embodiment, the interactive graphical path includes at least one suggested interactive analysis path based on associated Views (i.e., analytical data models as used in in-memory, relational database management systems, e.g., SAP® HANA) and at least one suggested interactive analysis path based on associated key-performance indicators (“KPIs”). In an embodiment, the relationship between the entities is determined based on a heuristic logic. In an embodiment, the heuristic logic can be based on at least one of (1) data source properties (2) user actions and (3) entity to entity predefined relationships. In an embodiment, the heuristic logic based on the data source properties includes similar attributes used by the data sources (i.e., at least one of the same tables, Views, dimensions, measures, attributes, metadata, and application components). In an embodiment, data sources including more properties in common will be ranked as more relevant than those data sources with fewer properties in common. Therefore, data sources with more properties in common with the entity will be suggested to the user with a higher probability than those with fewer properties in common. In an embodiment, only the most probable related entities will be suggested to the user. In an embodiment, for example, only the first 10 most probable related entities are suggested to the user. In another embodiment, the heuristic logic based on the data source properties includes similar KPIs used by the data sources (i.e., KPIs which have at least one of common data sources, attributes, and predefined associations). In an embodiment, the heuristic logic based on the user actions includes the graphical user interface application learning through repetitive analysis steps performed by the current user or other users. In an embodiment, each step of a path (i.e., going from one entity to another related entity) is registered in a memory database. In an embodiment, paths (e.g., from Material to Vendor) which are more frequently registered are more likely to be suggested to the user. In an embodiment, the entity to entity predefined relationships include relationships already defined by the user or software developer. In an embodiment, the predefined relationships between the entities, if they exist, have a higher probability of being suggested to the user than the heuristic logic based on (1) user actions and (2) the data source properties. In an embodiment, the heuristic logic based on (1) the user actions and (2) the data source properties are processed in parallel.

For example, with regard to the at least one suggested interactive analysis path based on associated Views, after the predefined relationships between the entities, user actions, such as Views previously used by the current user in the same context is given the highest weighting (i.e., a weighting of 10 based on a 1 to 10 ranking). Further, in an embodiment, other user actions, such as Views previously used by other users in the same context are given the second highest weighting (i.e., a weighting of 9 based on a 1 to 10 ranking). In another embodiment, Views associated with other entities which are configured with the same KPI/View as the source entity are given the next highest weighting (i.e., a weighting of 8 based on a 1 to 10 ranking). In another embodiment, Views associated with other entities having the same application component (e.g., sales order, history, etc.) as the KPI/View of the source entity are given the next highest weighting (i.e., a weighting of 7 based on a 1 to 10 ranking). Further, in another embodiment, Views associated with other entities having the same dimensions (e.g., Client, Material, Material Group, Material Name, Division, etc.) as the KPI/View of the source entity are given the next highest weighting (i.e., a weighting of 6 based on a 1 to 10 ranking).

Similarly, with regard to the suggested interactive analysis path based on associated KPIs, after the predefined relationships between the entities, user actions, such as KPIs previously used by the current user in the same context is given the highest weighting (i.e., a weighting of 10 based on a 1 to 10 ranking). Further, in an embodiment, other user actions, such as KPIs previously used by other users in the same context are given the second highest weighting (i.e., a weighting of 9 based on a 1 to 10 ranking). In another embodiment, KPIs with automatic dependencies (e.g., as previously predefined by a related KPI modeling application) to KPIs associated with the source entity are given the next highest weighting (i.e., a weighting of 8 based on a 1 to 10 ranking). In another embodiment, KPIs modeled on the same View as the KPI/View of the source entity are given the next highest weighting (i.e., a weighting of 7 based on a 1 to 10 ranking). In another embodiment, KPIs modeled on Views having the same application component (e.g., sales order, history, etc.) as the KPI/View of the source entity are given the next highest weighting (i.e., a weighting of 6 based on a 1 to 10 ranking). Further, in another embodiment, KPIs modeled on Views having the same dimensions (e.g., Client, Material, Material Group, Material Name, Division, etc.) as the KPI/View of the source entity are given the next highest weighting (i.e., a weighting of 5 based on a 1 to 10 ranking). In an embodiment, queries corresponding to the above heuristic logic (e.g., for the suggested interactive analysis path based on associated Views and the suggested interactive analysis path based on associated KPIs) are all processed in parallel. In another embodiment, the results of the heuristic logic for the suggested interactive analysis path based on associated Views are combined and rearranged based on the decreasing order of their weights. Similarly, the results of the heuristic logic for the suggested interactive analysis path based on associated KPIs are also combined and rearranged based on the decreasing order of their weights.

In an embodiment, selecting one of the associated Views or KPIs in the at least one suggested interactive analysis path applies the corresponding View or KPI corresponding to the other related entity to the original entity. In an embodiment, selecting one of the other related entities (i.e., KPI or View) in the at least one suggested interactive analysis path generates a new suggested interactive analysis path with corresponding related entities (i.e., KPIs or Views). Accordingly, the graphical user interface application provides for a holistic analysis of components corresponding to a business object. In an embodiment, the graphical user interface application also provides for a method of tracing the previous steps of the suggested interactive analysis path. In other words, the user is able to go back and forth between the first step (corresponding to the first entity) of a path to the most current step (corresponding to the most current entity). For example, if a suggested path for an entity “Material” consisted of related entities “Sales Organization, Vendor, Plant, Customer, Purchasing Document,” the user can move back and forth in analysis between “Material” and “Purchasing Document,” as desired. In an embodiment, the graphical user interface application provides for a method of saving the current state of an analysis path. For example, if the user saves the current state of the analysis path (e.g., “Sales Organization, Vendor, Plant, Customer, Purchasing Document”) for an entity “Material” at “Purchasing Document,” then, the next time the user logs into the system, the user can open the analysis path at “Purchasing Document.” Accordingly, the View or KPI of “Purchasing Document” is applied to the original entity, “Material.” In an embodiment, the graphical user application also provides for a filter which captures only those entity values (i.e., specific materials of “Material,” specific vendors of “Vendor,” etc.) which are of interest.

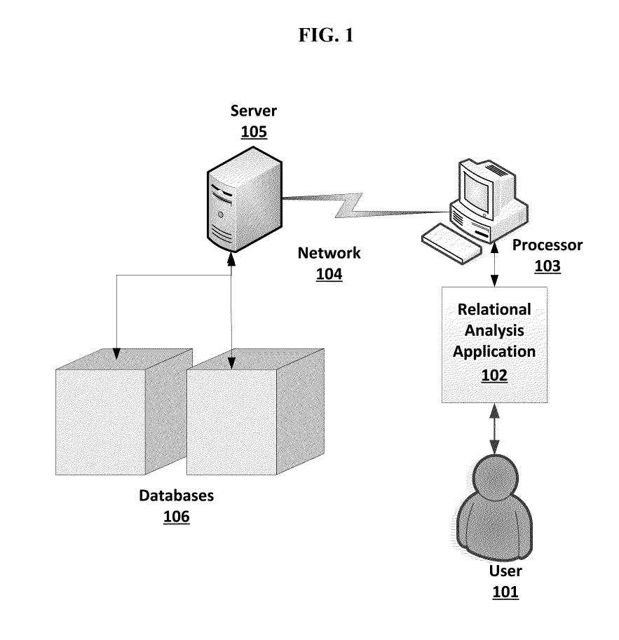

FIG. 1 illustrates an embodiment of a system utilizing a relational analysis graphical user interface application. In an embodiment, the system 100 consists of a user 101, a relational analysis application 102, a processor 103 (with a display), a network 104, a server 105 and databases 106. In an embodiment, database 106 is an in-memory database.

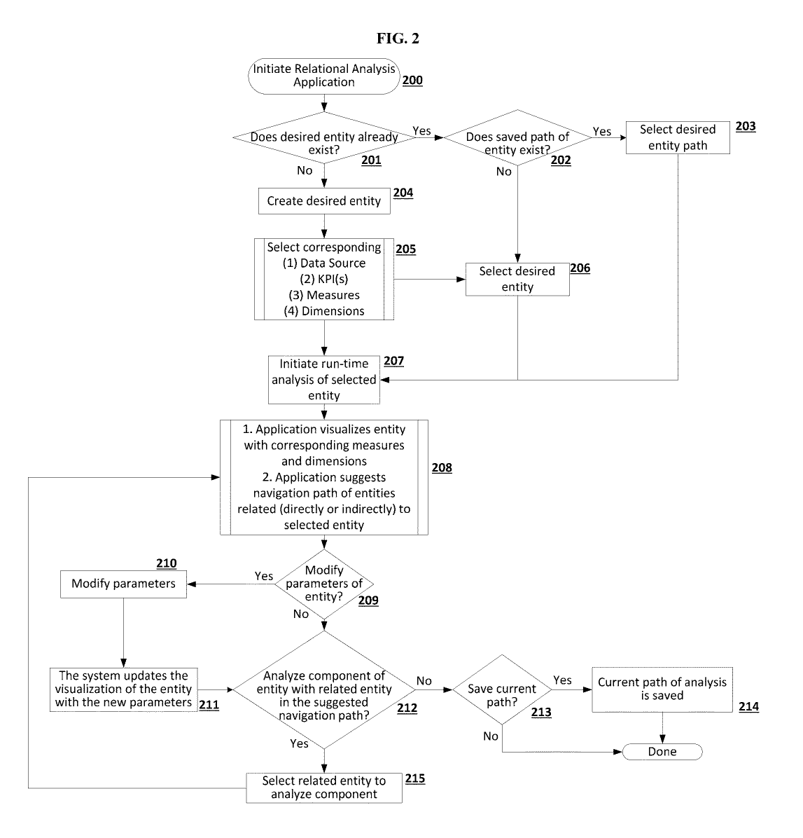

FIG. 2 illustrates an embodiment of a method of utilizing the relational analysis graphical user interface application. In step 200, the relational analysis application is initiated. In step 201, it is determined whether a desired entity already exists. If the desired entity does exist, then it is determined, in step 202, if a saved path of the entity exists. If a saved path of the desired entity exists, then, in step 203, the user selects the saved path of the desired entity. If a saved path of the desired entity does not exist, then in step 206, the user selects the desired entity. If the desired Entity does not exist, then, in step 204, the user creates a desired Entity. In step 205, the user creates the desired entity by defining, for example, (1) data source, (2) KPI(s), (3) measures, and (4) dimensions, with the relational analysis application. After the user creates the desired entity, in step 206, the user selects a desired entity to further analyze. Therefore, in step 207, the relational analysis application initiates a run-time analysis of the selected entity. For example, during run-time, in step 208, (1) the relational analysis application visualizes the entity with the corresponding measures and dimensions and (2) the relational analysis application suggests an analysis navigation path of entities related to the selected entity. Then, in step 209, it is determined if the user prefers to modify the previously defined (e.g., in step 205) parameters of the entity. If the user chooses to modify the parameters, then, in step 210, at least one of (1) the dimensions and (3) the measures is modified. After the parameters are modified, then, in step 211, the relational analysis application updates the visualization of the entity with the new parameters. Then, the method proceeds to step 212. If the user chooses not to modify the parameters of the entity in step 209, then the method also proceeds to step 212. In step 212, the user is presented with the option of analyzing a component of the entity with a related entity in the suggested navigation path. If the user chooses to analyze a component of the entity with a related entity in the suggested navigation path, then, in step 215, the user selects the desired entity in the suggested navigation path. After which, the method proceeds back to step 208. In other words, the relational analysis application (1) visualizes the selected entity with the corresponding measures and dimensions and (2) suggests another navigation path of related entities. However, if in step 212, the user chooses to cease analysis of an entity, then the method proceeds to step 213. In step 213, the user is presented with an option of saving the current path of the analysis (i.e., from the initial entity to the current related entity). Accordingly, if the user decides to save the current path of the analysis, the current path will be saved in step 214. After which, the method concludes. Similarly, if the user does not decide to save the current path in step 213, then the method will also conclude.

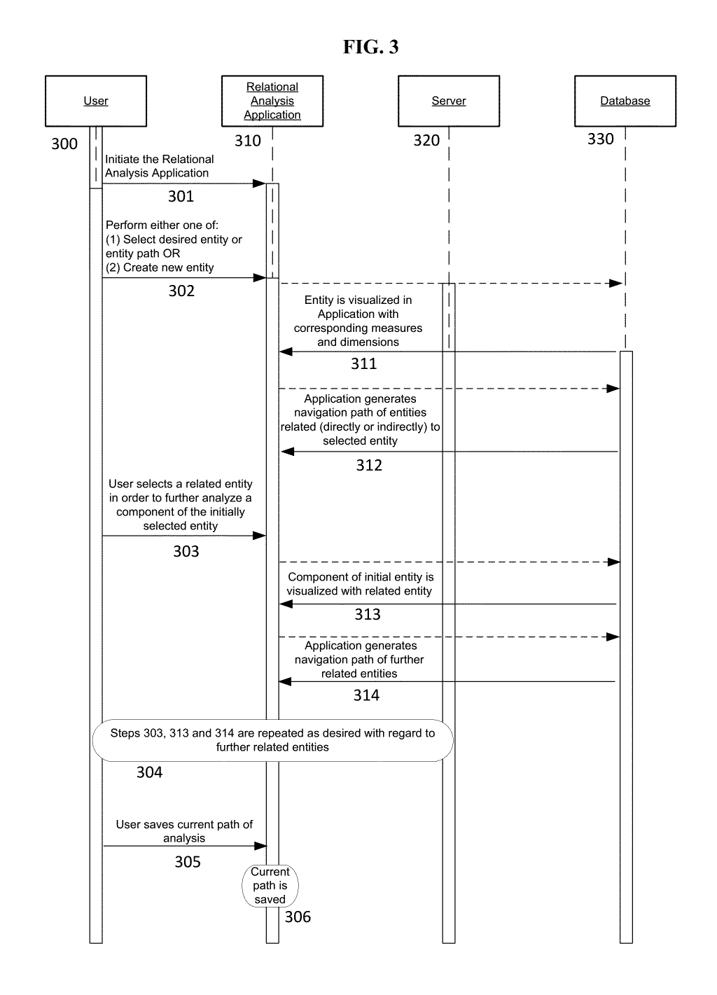

FIG. 3 illustrates an embodiment of the interaction between the elements of the system. In step 301, user 300 initiates the relational analysis application 310. In step 302, the user 300 either (1) selects a desired entity (or desired analysis path of the entity) or (2) creates a new entity, with the relational analysis application 310. In step 311, the desired entity is visualized in the relational analysis application 310 with the corresponding measures and dimensions. In step 312, the relational analysis application 310 generates the navigation path of the entities related (directly or indirectly) to the selected entity. In step 303, the user 300 selects a related entity in order to further analyze a component of the initially selected entity. Then, in step 313, the relational analysis application 310 visualizes an analysis of the selected component of the entity with the selected related entity of the navigation path. Further, in step 314, the relational analysis application 310 generates another suggested navigation path of related entities. Further, as depicted by step 304, steps 303, 313 and 314 are repeated as desired for each successive step in the analysis path (i.e., going from one entity to another related entity). In step 305, the user 300 saves the current path of the analysis (i.e., from the initial entity to the current related entity) with the relational analysis application 310 for later use. Accordingly, in step 306, the current path of the analysis is saved.

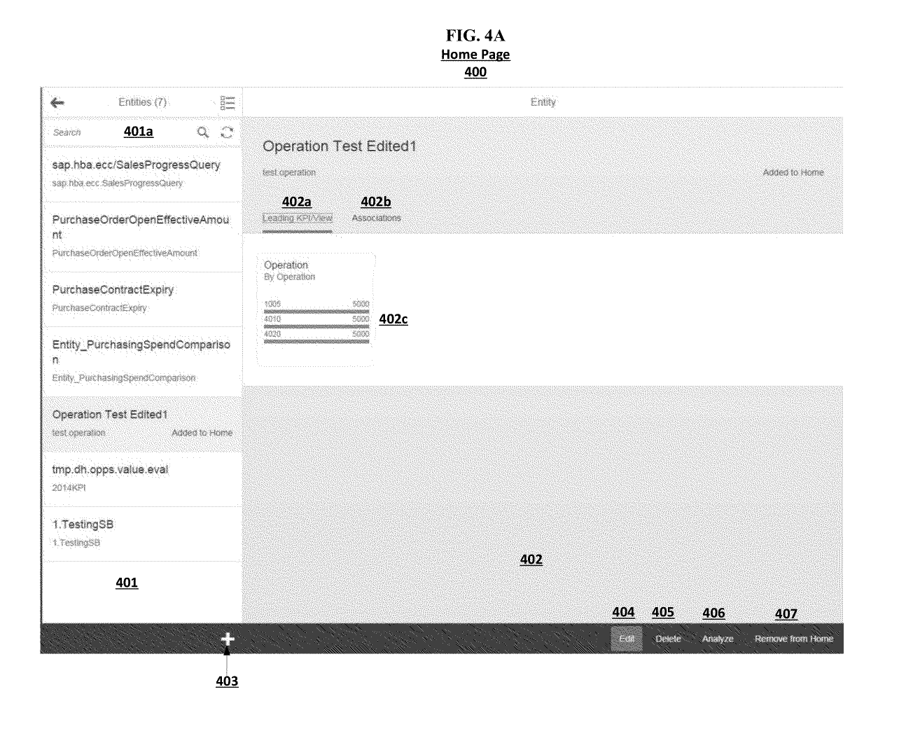

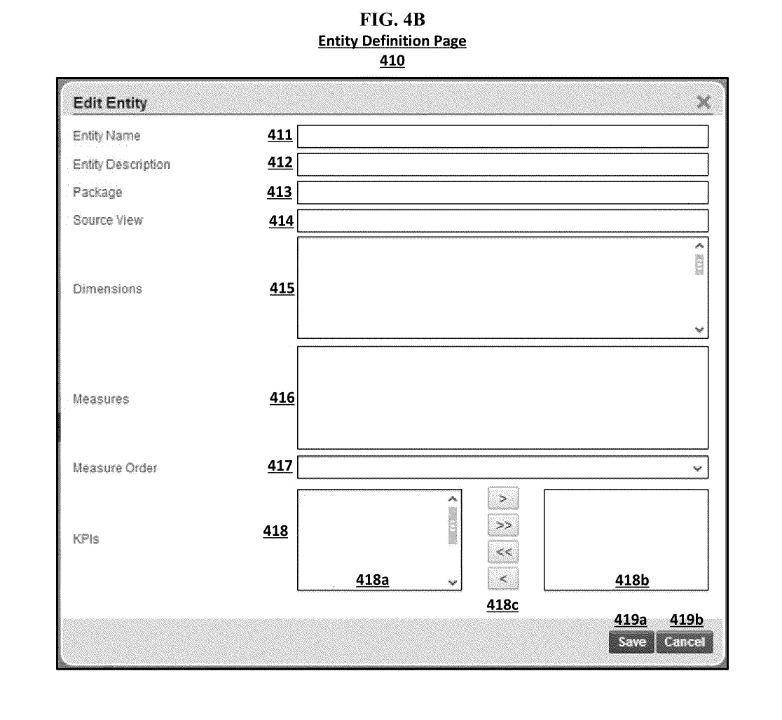

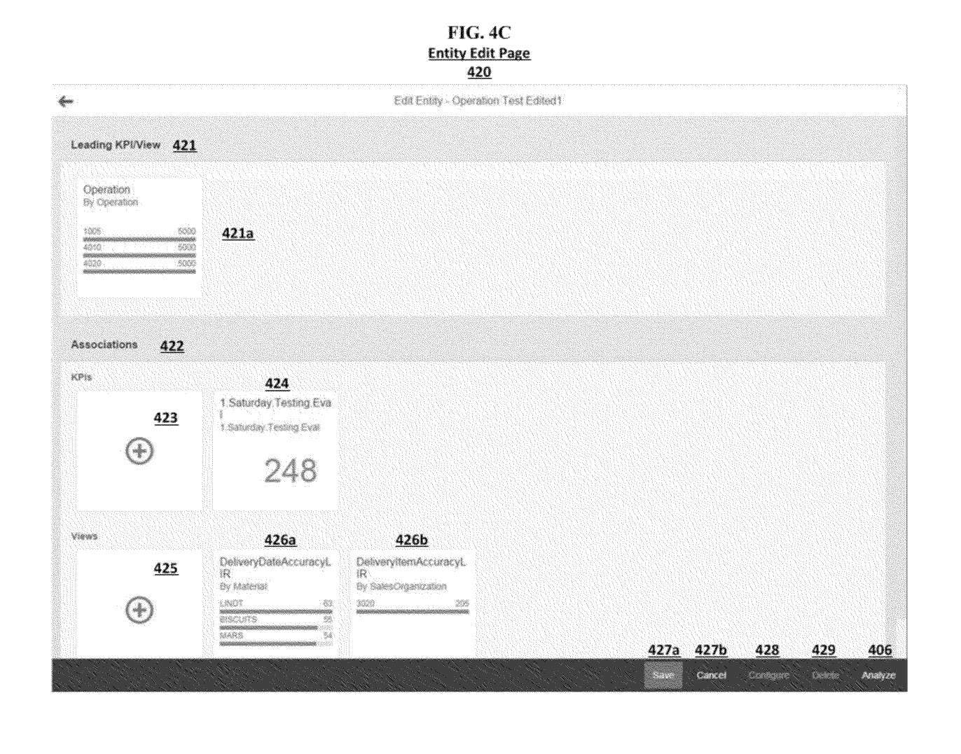

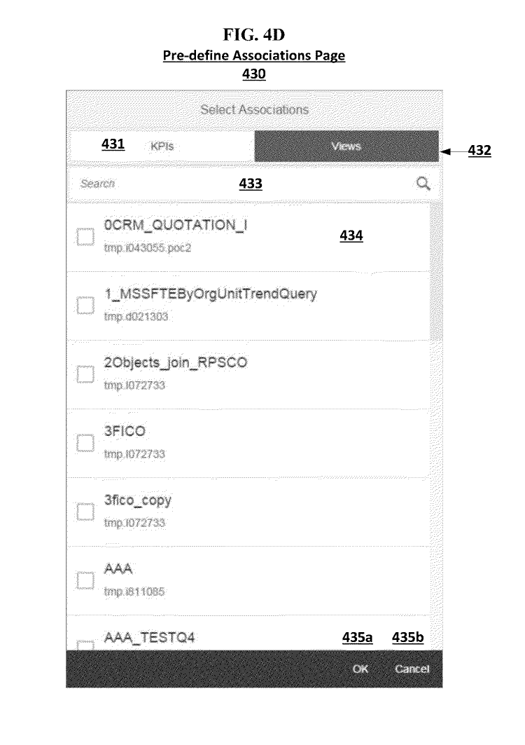

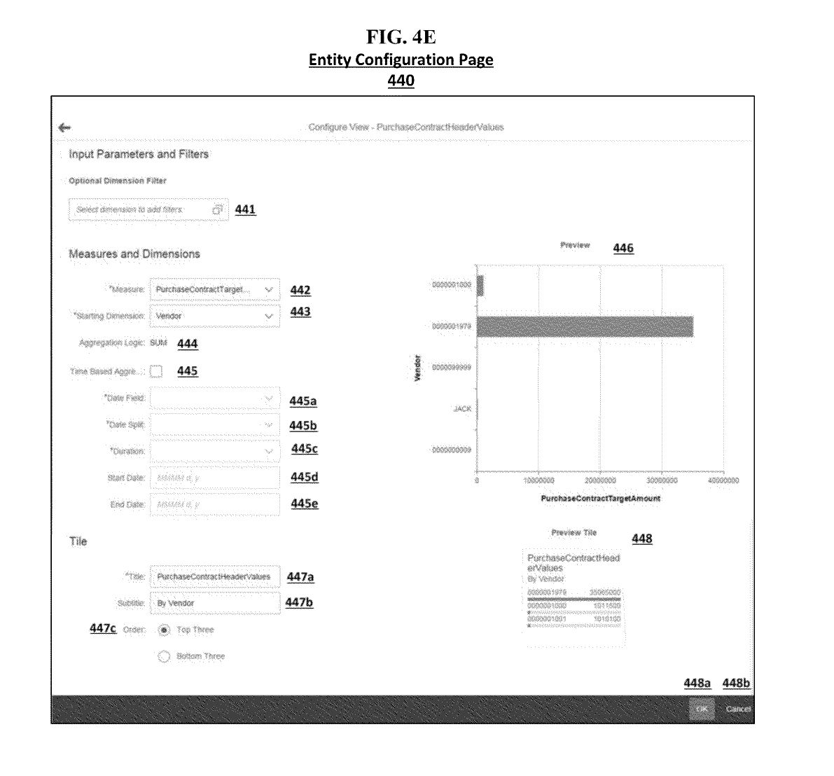

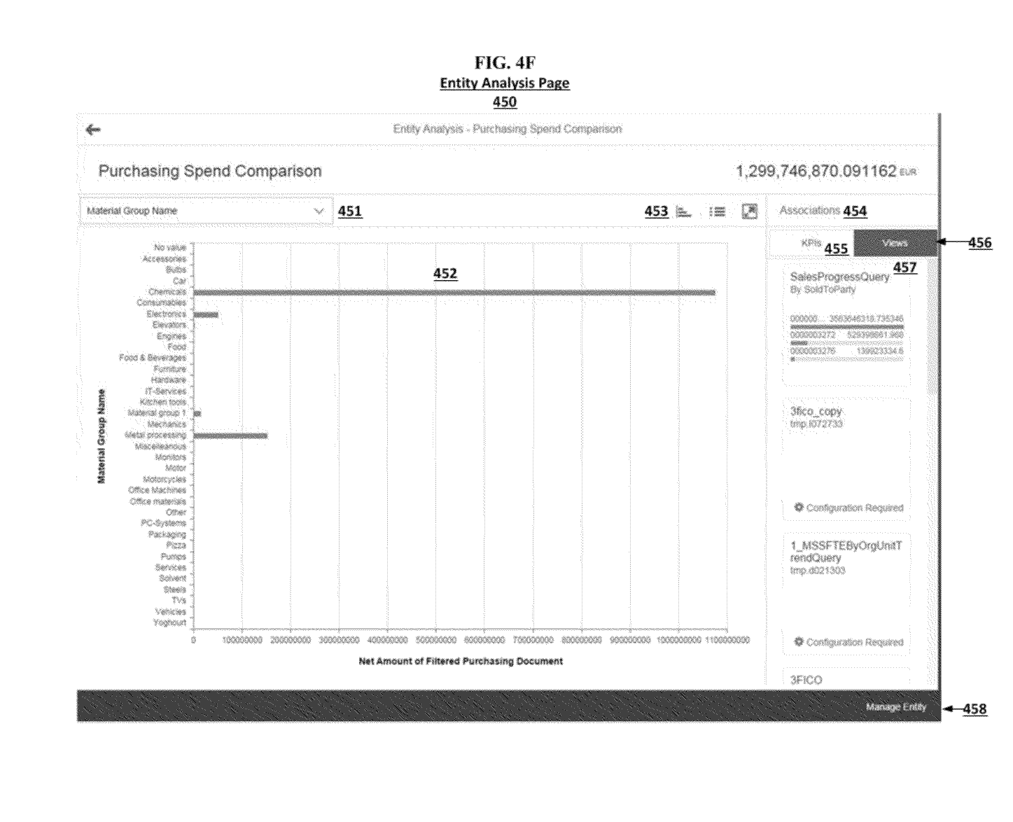

FIG. 4A illustrates an embodiment of the home page of the relational analysis application. In an embodiment, home page 400 includes a list of entities 401, a details area 402, an add entity button 403, an edit entity button 404, a delete entity button 405, an analyze entity button 406, and a remove button 407. In an embodiment, the list of entities 401 also includes a search bar 401a. In an embodiment, details area 402 includes information regarding the leading KPI/View (depicted in 402a) and the predefined associations (depicted in 402b) of the entity selected in list 401. In an embodiment, the leading KPI/View in 402a and the associations in 402b are represented by preview tiles (e.g., tile 402c). In an embodiment, the preview tiles are images representing certain information associated with the KPI/View (e.g., top three or bottom three data points associated with the KPI/View). In an embodiment, the user is able to individually view the details of either 402a or 402b by selecting either 402a or 402b, respectively. Further, in an embodiment, the user can add new entities to the home page 400 by selecting button 403. In another embodiment, selecting button 403 also causes the entity definition page 410 to be displayed. In another embodiment, selecting button 403 causes the entity configuration page 440 to be displayed instead of entity definition page 410. In an embodiment, if an entity is already added to the home page 400, the user is also given the option of removing a selected entity from the home page 400 with the remove button 407. In another embodiment, selecting the edit entity button 404 causes the entity edit page 420 to be displayed. In an embodiment, the entity edit page 420 allows the user to predefine associations (KPIs and Views) for the selected entity. In an embodiment, the user can analyze the selected entity by selecting the analyze entity button 406. Further, by selecting the analyze entity button 406, the entity analysis page 450 is displayed. In an embodiment, delete button 405 deletes the selected entity.

FIG. 4B illustrates an embodiment of the page utilized to define an entity. Entity definition page 410 includes a name input field 411, a description input field 412, a package input field 413, a source View input field 414 (i.e., analytical data models like calculation View and attribute View as used in in-memory, relational database management systems like SAP® HANA), a dimensions input field 415 (e.g., Material, Material Group, Material Name, Division), a measures input field 416 (e.g., Material Gross Weight, Material Net Weight), a measure order input field 417 (e.g., increasing or descending order), a KPIs input field 418, a save button 419a and a cancel button 419b. In an embodiment, the user is able to select KPIs from KPIs input list 418a (i.e., the list represents the available KPIs in the system) and transfer the selected KPIs (e.g., with transfer buttons 418c) to KPIs selected list 418b. Similarly, KPIs can be removed from the KPIs selected list 418b with transfer buttons 418c. In another embodiment, the entity configuration page 440 can be used to define the entity instead of the entity definition page 410.

FIG. 4C illustrates an embodiment of the page utilized to edit the entity. Entity edit page 420 includes an area 421, which depicts a preview tile 421a of the leading KPI/View of the selected entity. Entity edit page 420 also includes an associations area 422. Associations area 422 includes predefined associated KPIs in the form of a preview tile, e.g., 423, as well as predefined associated Views (also in the form of preview tiles), e.g., 426a and 426b. In another embodiment, entity edit page 420 also includes an add KPI button 423 and an add Views button 425. Selecting button 423 or 425 causes the pre-define associations page 430 to display. Buttons 423 and 425 provide a means for the user to pre-define associations between other entities (i.e., other KPIs and/or Views) and the current entity (i.e., current KPI or View). Entity edit page 420 also includes a save button 427a (i.e., to save the current modifications to the entity), a cancel button 427b (i.e., to cancel the current modifications to the entity), a configure button 428, a delete button 429 (i.e., to delete the entity) and the analyze button 406. In an embodiment, selecting the configure button 428 leads the user to the entity configuration page 440.

FIG. 4D illustrates an embodiment of the page utilized to pre-define the associations of the entity. As mentioned previously, selecting either button 423 or 425 leads the user to the pre-define associations page 430. Specifically, if button 425 is selected, the pre-define associations page 430 loads a Views area 432 including a suggested list 434 of other Views. In an embodiment, the suggested list of other views is determined as a result of the aforementioned heuristics logic. The suggested list 434 can be searched with search bar 433. In an embodiment, an association between the current View and any of the Views of suggested list 434 can be achieved by merely selecting the individual Views included in suggested list 434. Likewise, if button 423 is selected, the pre-define associations page 430 loads a KPIs area 431 including a suggested list 434 of other KPIs. In an embodiment, the suggested list of other KPIs is determined as a result of the aforementioned heuristics logic. The suggested list 434 can be searched with search bar 433. In an embodiment, an association between the current KPI and any of the KPIs of suggested list 434 can be achieved by merely selecting the individual KPIs included in suggested list 434. In an embodiment, once the pre-define associations page 430 is open; the user can go back and forth from KPI area 431 and views area 432 by selecting each respective area. In an embodiment, pre-define associations page 430 also includes confirm button 435a (i.e., to confirm the associations) and cancel button 435b (i.e., to cancel the selections).

FIG. 4E illustrates an embodiment of the page utilized to configure the visualization of the entity during runtime. Entity configuration page 440 provides a means for the user to apply specific filters to the entity which will appear during runtime. In an embodiment, the entity configuration page 440 includes optional dimension filter input field 441, measure input field 442, starting dimension field 443, aggregation logic 444 (i.e., defining how the data corresponding to the entity will be aggregated), time based aggregation logic check box 445, date input field 445a, date split input field 445b, duration input field 445c, start date input field 445d and end date input field 445e. Entity configuration page 440 also includes preview graph 446 which depicts how the entity (i.e., KPI or view) will be displayed after the filters selected in the entity configuration page 440 are applied. Entity configuration page 440 also includes a tile input field 447a, a subtitle input field 447b and an order input field 447c (i.e., to select either an increasing or decreasing order of the data to be displayed in the preview tile). Entity configuration page 440 also includes a preview tile corresponding to the values selected and inputted for input fields 447a, 447b and 447c. In an embodiment, preview tile 448 is also displayed on the home page 400 (e.g., 402c) and the edit entity page 420 (e.g., tile 421a). In another embodiment, entity configuration page 440 can be used to define the entity instead of the entity definition page 410. In other words, the page used to initially define the entity will also be the same page used to configure the visualization of the entity (i.e., entity configuration page 440).

FIG. 4F illustrates an embodiment of the page utilized to analyze the entity. Entity analysis page 450 includes dimension filter field 451, graph area 452, switch graph button 453, the suggested analysis area 454, suggested KPI analysis path 455, suggested Views analysis path 456, suggested analysis list (corresponding to either suggested KPI analysis path 455 or suggested Views analysis path 456, depending on which is selected) and manage entity button 458. In an embodiment, dimension filter field 451 provides a means for the user to filter the visualization of the entity in graph area 452 by relevant dimensions. In an embodiment, applying a certain filter from dimension filter field 451 to the current entity also influences (i.e., modifies) the suggested KPI analysis path 455 and the suggested Views analysis path 456. In other words, the suggested KPI analysis path 455 and the suggested Views analysis path 456 are updated with suggested KPIs and Views which correspond to the selected dimension in the dimension filter field 451. In an embodiment, if a certain object in the graph area 452 includes further granularities (or subcomponents), then selecting that certain object in graph area 452 (e.g., “Chemicals”) modifies the visualization of the graph area 452 (e.g., filters the graph) to display the granularities (or subcomponents) of the selected object (e.g., display further granularities or subcomponents of “Chemicals”). Further, in an embodiment, selecting a certain object within graph area 452 also influences (i.e., modifies) the suggested KPI analysis path 455 and the suggested Views analysis path 456. In other words, the suggested KPI analysis path 455 and the suggested Views analysis path 456 are updated with suggested KPIs and Views which correspond to the selected object in the graph area 452. In an embodiment, the suggested analysis list 457 (corresponding to either suggested KPI analysis path 455 or suggested Views analysis path 456) is determined on the basis of the aforementioned heuristic logic. In an embodiment, selecting a suggested KPI or View from suggested list 457 applies the corresponding View or KPI to the current entity, thereby modifying the visualization of the entity in graph area 452 according to the selected KPI/View. Further, in an embodiment, selecting either a KPI or View from the at least one suggested interactive analysis path also generates a new suggested interactive analysis path with corresponding related entities (KPIs and/or Views). Further, in an embodiment, the user is able to view the graph area in different formats (e.g., bar graph, line graph, pie chart, etc.) by selecting switch graph button 453. In an embodiment, selecting the manage entity button 458 leads the user to the entity configuration page 440.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

Although the foregoing invention has been described in some detail for purposes of clarity of understanding, it will be apparent that certain changes and modifications can be practiced within the scope of the appended claims. The described embodiment features can be used with and without each other to provide additional embodiments of the present invention. The present invention can be practiced according to the claims without some or all of these specific details. For the purpose of clarity, technical material that is known in the technical fields related to the invention has not been described in detail so that the present invention is not unnecessarily obscured. It should be noted that there are many alternative ways of implementing both the process and apparatus of the present invention. Accordingly, the present embodiments are to be considered as illustrative and not restrictive, and the invention is not to be limited to the details given herein, but can be modified within the scope and equivalents of the appended claims.

What is claimed is:

1. A computer-implemented method for analyzing a first business object corresponding to a first data source with a graphical user interface application, the method comprising:
retrieving, with a processor, the first data source from a database;
displaying, on the graphical user interface application, a graphical representation of the first business object, wherein the graphical representation of the business object is a function of user-defined inputs for: (1) the first data source, (2) at least one instance of at least one dimension from the first data source, (3) a figure on which the at least one dimension from the first data source is measured, and (4) at least one key performance indicator (KPI) corresponding to the first data source;
generating, with the processor, at least one graphical analysis path, wherein the at least one graphical analysis path is determined as a function of a heuristic logic corresponding to (1) user actions (2) shared properties between the first data source and at least one other data source and (3) predefined relationships between the first business object and at least one other business object; and
displaying the at least one graphical analysis path on the graphical user interface application, wherein applying user-selected components of the graphical analysis path to the graphical representation of the first business object modifies a visualization of the graphical representation of the first business object, wherein selecting a selectable component of the graphical representation of the first business object modifies the visualization of the graphical representation of the first business object and generates another at least one graphical analysis path as a function of the heuristic logic in connection with properties of the selected component.

2. The method of claim 1, wherein the first business object corresponds to one of (1) the KPI corresponding to the first data source or (2) an analytical data model, of a relational database management system, corresponding to the first data source.

3. The method of claim 2, wherein the at least one graphical analysis path corresponds to at least one of (1) KPIs corresponding to the at least one other data sources and (2) analytical data models corresponding to the at least one other data sources.

4. The method of claim 3, wherein the components in the at least one graphical analysis path are displayed based on a weighting determined by the heuristic logic.

5. The method of claim 4, wherein the weighting of the heuristic logic for the graphical analysis path corresponding to the KPIs is a function of (1) user actions by a current user in a similar context (2) user actions by another user in the similar context (3) KPIs modeled on a same analytical data model as the first business object (4) KPIs modeled on analytical data models having a similar application component as the first business object (5) KPIs modeled on analytical data models having similar dimensions as the first business object and (6) KPIs having automatic dependencies to other KPIs.

6. The method of claim 4, wherein the weighting of the heuristic logic for the graphical analysis path corresponding to the analytical data models is a function of (1) user actions by a current user in a similar context (2) user actions by another user in the similar context (3) analytical data models having a similar application component as the first business object (4) analytical data models having similar dimensions as the first business object and (5) analytical data models including business objects in common with either the KPI or the analytical data model corresponding to the first business object.

7. The method of claim 3, wherein the components in the at least one graphical analysis path are represented by an image corresponding to (1) a KPI or (2) an analytical data model.

8. A non-transitory computer readable medium containing program instructions for analyzing a first business object corresponding to a first data source with a graphical user interface application, wherein execution of the program instructions by one or more processors of a computer system causes one or more processors to carry out the steps of:
retrieving, with a processor, the first data source from a database;
displaying, on the graphical user interface application, a graphical representation of the first business object, wherein the graphical representation of the business object is a function of user-defined inputs for: (1) the first data source, (2) at least one instance of at least one dimension from the first data source, (3) a figure on which the at least one dimension from the first data source is measured, and (4) at least one key performance indicator (KPI) corresponding to the first data source;
generating, with the processor, at least one graphical analysis path, wherein the at least one graphical analysis path is determined as a function of a heuristic logic corresponding to (1) user actions (2) shared properties between the first data source and at least one other data source and (3) predefined relationships between the first business object and at least one other business object; and
displaying the at least one graphical analysis path on the graphical user interface application, wherein applying user-selected components of the graphical analysis path to the graphical representation of the first business object modifies a visualization of the graphical representation of the first business object, wherein selecting a selectable component of the graphical representation of the first business object modifies the visualization of the graphical representation of the first business object and generates another at least one graphical analysis path as a function of the heuristic logic in connection with properties of the selected component.

9. The non-transitory computer readable medium of claim 8, wherein the first business object corresponds to one of (1) the KPI corresponding to the first data source or (2) an analytical data model, of a relational database management system, corresponding to the first data source.

10. The non-transitory computer readable medium of claim 9, wherein the at least one graphical analysis path corresponds to at least one of (1) KPIs corresponding to the at least one other data sources and (2) analytical data models corresponding to the at least one other data sources.

11. The non-transitory computer readable medium of claim 10, wherein the components in the at least one graphical analysis path are displayed based on a weighting determined by the heuristic logic.

12. The non-transitory computer readable medium of claim 11, wherein the weighting of the heuristic logic for the graphical analysis path corresponding to the KPIs is a function of (1) user actions by a current user in a similar context (2) user actions by another user in the similar context (3) KPIs modeled on a same analytical data model as the first business object (4) KPIs modeled on analytical data models having a similar application component as the first business object (5) KPIs modeled on analytical data models having similar dimensions as the first business object and (6) KPIs having automatic dependencies to other KPIs.

13. The non-transitory computer readable medium of claim 11, wherein the weighting of the heuristic logic for the graphical analysis path corresponding to the analytical data models is a function of (1) user actions by a current user in a similar context (2) user actions by another user in the similar context (3) analytical data models having a similar application component as the first business object (4) analytical data models having similar dimensions as the first business object and (5) analytical data models including business objects in common with either the KPI or the analytical data model corresponding to the first business object.

14. The non-transitory computer readable medium of claim 10, wherein the components in the at least one graphical analysis path are represented by an image corresponding to (1) a KPI or (2) an analytical data model.

15. A system directed to analyzing a first business object corresponding to a first data source with a graphical user interface application, the system comprising:
a database;
a display;
a processor, wherein the process is configured to perform the steps of:
retrieving, with a processor, the first data source from the database;
displaying, on the graphical user interface application on the display, a graphical representation of the first business object, wherein the graphical representation of the business object is a function of user-defined inputs for: (1) the first data source, (2) at least one instance of at least one dimension from the first data source, (3) a figure on which the at least one dimension from the first data source is measured, and (4) at least one key performance indicator (KPI) corresponding to the first data source;
generating, with the processor, at least one graphical analysis path, wherein the at least one graphical analysis path is determined as a function of a heuristic logic corresponding to (1) user actions (2) shared properties between the first data source and at least one other data source and (3) predefined relationships between the first business object and at least one other business object; and
displaying the at least one graphical analysis path on the graphical user interface application on the display, wherein applying user-selected components of the graphical analysis path to the graphical representation of the first business object modifies a visualization of the graphical representation of the first business object, wherein selecting a selectable component of the graphical representation of the first business object modifies the visualization of the graphical representation of the first business object and generates another at least one graphical analysis path as a function of the heuristic logic in connection with properties of the selected component.

16. The system of claim 15, wherein the first business object corresponds to one of (1) the KPI corresponding to the first data source or (2) an analytical data model, of a relational database management system, corresponding to the first data source.

17. The system of claim 16, wherein the at least one graphical analysis path corresponds to at least one of (1) KPIs corresponding to the at least one other data sources and (2) analytical data models corresponding to the at least one other data sources.

18. The system of claim 17, wherein the components in the at least one graphical analysis path are displayed based on a weighting determined by the heuristic logic.

19. The system of claim 18, wherein the weighting of the heuristic logic for the graphical analysis path corresponding to the KPIs is a function of (1) user actions by a current user in a similar context (2) user actions by another user in the similar context (3) KPIs modeled on a same analytical data model as the first business object (4) KPIs modeled on analytical data models having a similar application component as the first business object (5) KPIs modeled on analytical data models having similar dimensions as the first business object and (6) KPIs having automatic dependencies to other KPIs.

20. The system of claim 18, wherein the weighting of the heuristic logic for the graphical analysis path corresponding to the analytical data models is a function of (1) user actions by a current user in a similar context (2) user actions by another user in the similar context (3) analytical data models having a similar application component as the first business object (4) analytical data models having similar dimensions as the first business object and (5) analytical data models including business objects in common with either the KPI or the analytical data model corresponding to the first business object.
